(19) United States
(12) Patent Application Publication
(10) Pub. No.: US 2009/0039700 A1
(43) Pub. Date: Feb. 12, 2009

(54) SOLID REAR AXLE FOR AN AUTOMOTIVE VEHICLE

(75) Inventors: Mircea Gradu, Canton, OH (US); Stuart W.J. Hamilton, Canton, OH (US); Steven A. Roman, Canton, OH (US); Praveen M. Pauskar, Canton, OH (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: The Timken Company, Canton, OH (US)

(21) Appl. No.: 11/836,596

(22) Filed: Aug. 9, 2007

(51) Int. Cl. B60B 23/00; F16C 13/02

(52) U.S. Cl. 301/111.02; 301/126; 384/589

(57) ABSTRACT

A solid axle for the driving wheels of an automotive vehicle has axle tubes through which axle shafts extend. Each tube at its outboard end is fitted with a wheel end, including a housing that is secured firmly to the tube, a hub having a drive flange located beyond the housing and a spindle that projects into the housing, and an antifriction bearing located between the housing and the hub spindle. Each axle shaft at its outboard end has a drive spindle that emerges from shoulder. The drive spindle projects through the hub at the end of its axle shaft and beyond the hub is deformed outwardly over a surface of the hub in the provision of a formed end, so that the hub is captured between the shoulder and the formed end, thus unifying the axle shaft and wheel end.

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

This invention relates in general to axles for automotive vehicles, and more particularly to a solid rear axle and a unified subassembly for the axle.

Some automotive vehicles, particularly light trucks and sport utility vehicles, use solid rear axles of the semifloating variety to transfer torque to the driving wheels for such vehicles. The typical semifloating rear axle has axle tubes that are fastened to and extend from an axle center that contains differential gearing. The gearing drives two axle shafts that extend through the tubes and at their ends are provided with hubs to which road wheels are secured along with brake disks or drums. Antifriction bearings support the outer ends of the axle shafts in their axle tubes and enable the shafts to rotate in the tubes with minimal friction. In some solid axles so-called unit bearings serve this purpose. They not only transfer radial loads between the axle tube and wheels, but also thrust loads in both directions. See U.S. Pat. Nos. 3,397,020 and 5,735,612. Other axles rely on cylindrical roller bearings that transfer only radial loads and clips and abutments located within the axle center to resist thrust loads.

Whatever the mechanisms for supporting the axle shafts in their axle tubes and accommodating thrust loading, they are somewhat complex. The complexity imparts difficulty to assembling and repairing solid axles. Moreover, both unit bearings and cylindrical roller bearing operate with radial clearances, and this detracts from the stability of the axle shafts.

### BRIEF SUMMARY OF THE INVENTION

Briefly stated, the present invention resides in a solid axle, including an axle center and axle tube that extends from the axle center. At its end the tube is fitted with a wheel end, including a housing that is secured to the tube, a hub having a drive flange located beyond the housing and a spindle that projects from the drive flange into housing, and an antifriction bearing located between the housing and the hub spindle. The axle also includes an axle shaft coupled to gearing in the axle center and extending to the hub of the wheel end, with the outboard end of the shaft being captured in the hub, so that the wheel end and axle shaft is unified. The invention also resides in the wheel end with the axle shaft captured in it.

### BRIEF DESCRIPTION OF THE DRAWINGS

In the accompanying drawings which form part of the specification:

FIG. 1 is a perspective view of a solid axle constructed in accordance with and embodying the present invention;

FIG. 2 is a fragmentary perspective view, partially broken away and in section, of a wheel end, axle tube and axle shaft forming part of the present invention;

FIG. 3 is a sectional view taken along line 3-3 of FIG. 2; and

FIG. 4 is another fragmentary perspective view, partially broken away and in section, of the unified wheel end and axle shaft of the present invention.

### DETAILED DESCRIPTION

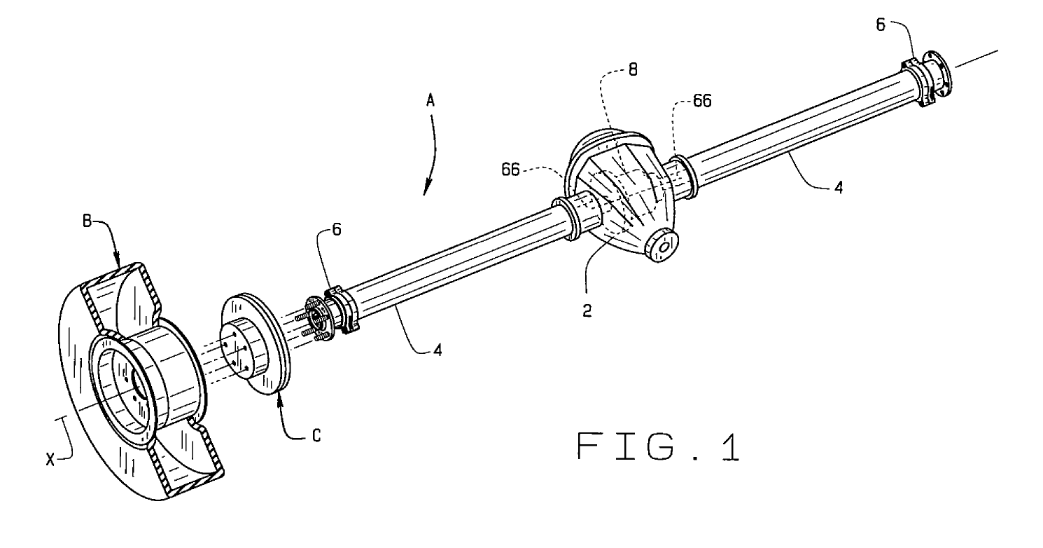

Referring to the drawings, a solid axle A (FIG. 1) for an automotive vehicle couples road wheels B to the vehicle and further transfers torque to those wheels B to propel the vehicle. The axle A basically includes an axle center 2 and axle tubes 4 that extend laterally from the axle center 2. At their outer end the axle tubes 4 are fitted with wheel ends 6 to which the road wheels B are attached along with brake drums or disks C. Indeed, the wheel ends 6 enable the road wheels B to rotate about a common axis X. The axle center 2 contains differential gearing 8, whereas the axle tubes 4 house axle shafts 10 that transfer torque from the gearing 8 to the wheel ends 6 which in turn transfer it to the road wheels B.

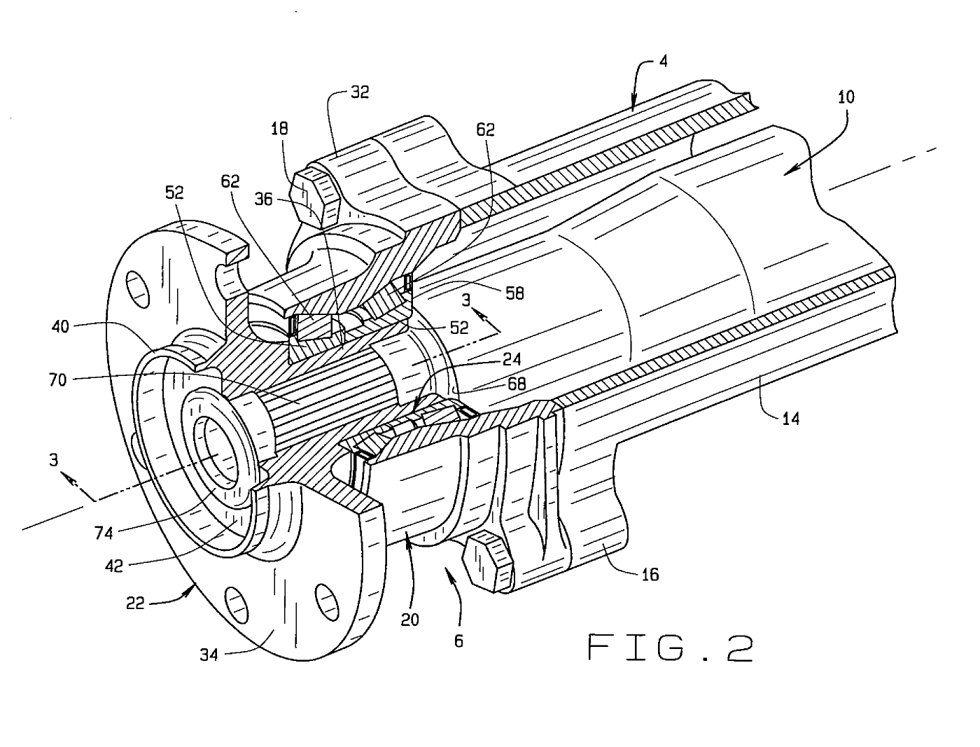

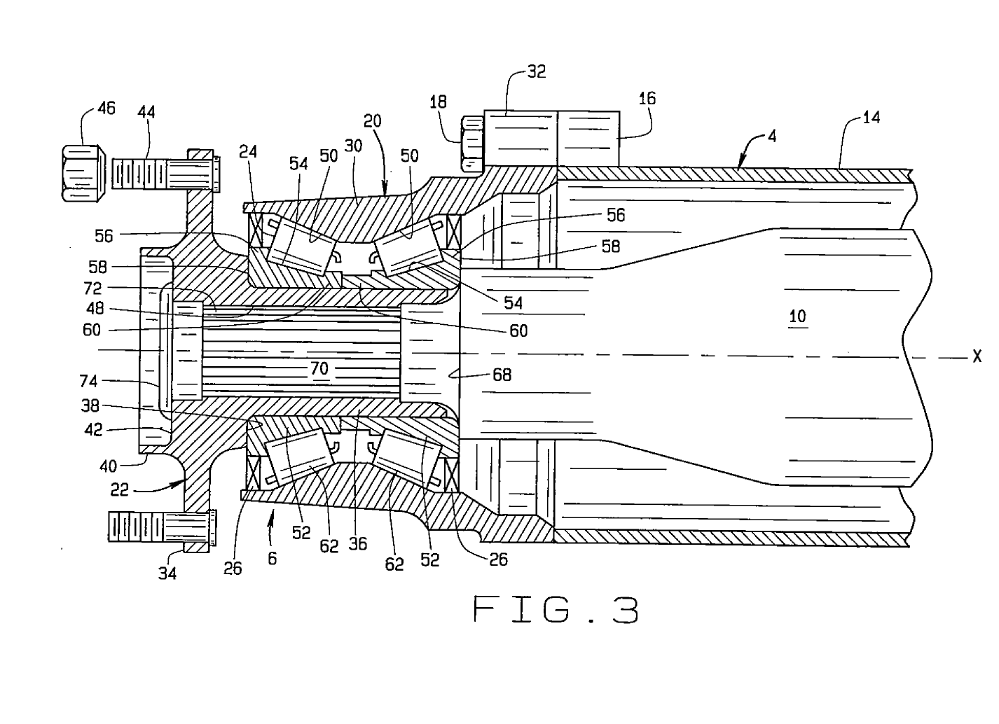

Each axle tube 4 includes (FIGS. 2 and 3) a tubular section 14 of extended length and a flange 16 at the outer end of the tubular section. At its inner end the tubular section is attached firmly to the axle center 2. At its outer end one of the wheel ends 6 is secured firmly to the flange 14 with bolts 18.

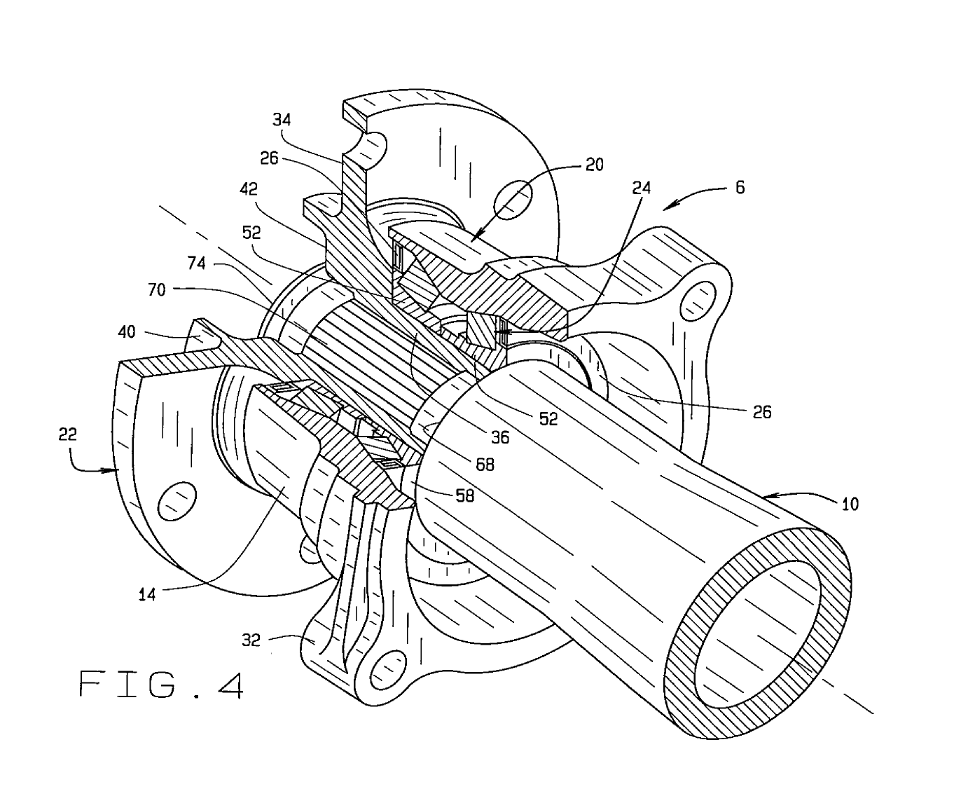

That wheel end 6 includes (FIGS. 2-4) a housing 20 that is attached to and remains fixed with respect to its axle tube 4 and a hub 22 to which is connected to the axle shaft 10 that is within the tube 4 as well as the road wheel B and brake disk C. In addition, the wheel end 6 includes an antifriction bearing 24 that enables the hub 22 to rotate in the housing 20 with minimal friction and to further transfer radial loads between the housing 20 and hub 22 as well as thrust loads in both axial directions. Finally, the wheel end 6 has one or more seals 26 that isolate the bearing 24, preventing contaminants from entering it, while retaining a lubricant within it.

The housing 20 has (FIG. 3) a tubular section 30 and at one end, its inboard end, a flange 32 that fits against the flange 16 at the outer end of the axle tube 4. Indeed, the housing 20 is secured firmly to the flange 16 of the axle tube 4 with the bolts 18, which may thread into either flange 16 or 32.

The hub 22 has (FIG. 3) a drive flange 34 that rotates beyond the outboard end of the housing 20 and a hollow spindle 36 that projects into the hollow interior of the tubular section 30 of the housing 20. Actually, the spindle 36 emerges from the drive flange 34 at a shoulder 38 and possesses a uniform outside diameter beyond the shoulder, all the way to its end. On its opposite face the drive flange 34 has a wheel pilot 40 that projects away from the flange 34 and within the wheel pilot 40 a flat surface 42 that lies perpendicular to the axis X. The wheel pilot 40 serves to center the road wheel B and brake disk C on the hub 22. The road wheel B and brake disc C may be attached to the hub 22 with lug bolts 44 that project from the drive flange 34 through the disk C and wheel B and with nuts 46 that thread over the bolts 44, or by other suitable conventional means. The hub 22 contains an internal spline 48 that lies primarily within its hollow spindle 36.

The bearing 24 takes the form of a double row tapered roller bearing, and as such has the capacity to transfer large radial loads through the wheel end 6 as well as thrust loads in both axial directions. The bearing 24 includes (FIG. 3) outboard and inboard outer raceways 50 that taper downwardly toward each other. Preferably, they form surfaces on the housing 20 itself, but they may be on separate races called cups that are fitted into the housing 20 or on a single separate race called a double cup. In addition, the bearing 24 has inner races in the form of outboard and inboard cones 52 that are fitted over the spindle 36 with interference fits. Each cone 52 has a tapered raceway 54 that is presented outwardly away from the axis X and a thrust rib 56 at the large end of the raceway 54. The thrust rib 56 leads out to a back face 58. At the opposite end of its raceway 54 the cone 52 has a small end rib 60. The outboard cone 52 fits over the hub spindle 36 with its back face 58 against the shoulder 38 where the spindle 36 emerges from the drive flange 34. Its raceway 54 is presented toward the outboard outer raceway 50 and is inclined in the same direction. The inboard inner cone 52 fits over the hub spindle 36 with its small end rib 60 abutting the small end rib 60 of the outboard cone 52. Its raceway 54 is presented outwardly toward the inboard outer raceway 50 and is inclined in the same direction. The back face 58 of the inboard cone 52 lies axially inwardly beyond the inboard end of the spindle 36. Finally, the bearing 24 has rolling elements in the form of tapered rollers 62 arranged in two rows—one between the outboard outer raceway 50 and the raceway 54 of the outboard cone 52 and the other between the inboard outer raceway 50 and the raceway 54 of the inboard cone 52. The lengths of the small end ribs 60 on the two cones 52 determine the setting for the bearing 24, and preferably that is one of slight preload in which no clearances exist in the bearing 24. Moreover, the rollers 62 of each row are on apex, meaning that the conical envelopes in which the rollers 62 lie, and the conical envelopes in which their raceways 50 and 54 lie, as well, all have their apices at a common point along the axis X. The outboard inner cone 52 may be integrated into the hub spindle 36, so that its raceway 54 and thrust rib 56 form surfaces of the hub 22.

The seals 26 fit between the housing 20, beyond the outer raceways 50 in the housing 20, and the thrust ribs 56 of the two cones 52 and thus close the annular spaces beyond the large ends of the tapered rollers 62, establishing dynamic fluid barriers in those spaces that retain a lubricant, normally grease. Alternative seal configurations and lubrication systems may be utilized, for example, only a single seal 26 at the outboard position, with lubrication furnished by axle oil from the axle center 2.

Each axle shaft 10 is preferably tubular for most of its length, although smaller in diameter than the inside diameter of the axle tube 4 through which it extends. At its inboard end the axle shaft 10 has (FIG. 1) a spline 66 which mates with a spline in a beveled side gear forming part of the differential gearing 8 contained in axle center 2. While the inboard spline 66 couples the axle shaft 10 to the differential gearing 8 in the axle center 2 to transfer torque, the connection does not prevent the shaft 10 from being released from axle center 2 and withdrawn from the tube 4. No clips, abutments, or other devices are required at the axle center 2 to accommodate thrust loads.

At its outboard end the axle shaft 10 has (FIGS. 2-4) a shoulder 68 and a drive spindle 70 that projects axially from the shoulder 68, its center being the axis X. The drive spindle 70 projects completely through the hollow interior of the hub 22, whereas the shoulder 68 abuts the back face 58 of the inboard cone 52. The drive spindle 70 has an external spline 72 that engages the internal spline 48 in the hub 22, so that torque applied to the axle shaft 10 is transferred to the hub 22 of the wheel end 6 through the mating splines 48 and 72. Beyond the spline 72 the drive spindle 70 has an outwardly directed formed end 74 that lies within the wheel pilot 40 of the hub 22 and overlies the flat surface 42 that the wheel pilot 40 surrounds. Thus, the hub 22 of the wheel end 6 and the two cones 52 of the bearing 24 are captured between the shoulder 68 and the formed end 74 of the axle shaft 10, so the axle shaft 10 cannot be withdrawn from the hub 22. In that sense the wheel end 6 and the axle shaft 10 are unified into a subassembly, although the axle shaft 10 and the hub 22 can rotate relative to the housing 20.

The drive spindle 70 of the axle shaft 10 does not initially have the formed end 74. Prior to insertion through the hub 22 it has an axially directed segment that is no greater in diameter than the inside diameter of the internal spline 48. This enables the segment to fit through the spline 48 and the shoulder 68 to come against the back face 58 of the inboard cone 52. Only then is the axially directed segment deformed outwardly in a roll forming procedure to produce the formed end 74. A nut threaded over the end of the drive spindle or some other securement device may be substituted for the formed end 74.

The suspended weight of the vehicle is transferred to the axle tubes 4 of the axle A through springs or the like and is transferred to the road wheels B through the wheel ends 6. In this regard, the suspended weight of the vehicle transfers from the housing 20 of each wheel end 6, through the bearing 6 of the wheel end 6 to the hub 22 of the wheel end 6 and thence to the road wheel B. The tapered rollers 62 transfer radial loading between the housing 20 and hub 22. They also transfer thrust loads in both axial directions. Thus, the inertial loads encountered in negotiating turns in either direction are transferred from the housing 20 through the rollers 62 of one row or the other to the hub 22 and thence to road wheel B. The axle shaft 10 at each wheel end 6 carries no radial or thrust loads and in that sense the axle A is similar to a full-floating axle.

Torque that is delivered to the axle A at its axle center 2 passes through the differential gearing 8 where it is divided between the two axle shafts 10. At the end of each axle shaft 10 the torque transfers to the hub 22 for the wheel end 6 at that end, with the transfer passing through mating splines 48 and 72 of the hub 22 and drive spindle 70, respectively. The hub 22 transfers the torque to the road wheel B.

The bearings 24 of the wheel ends 6 need not be a tapered roller bearing, although tapered roller bearings are the best suited for the wheel ends 6. Other types of antifriction bearings having inclined raceways will suffice, such as angular contact ball bearings and spherical roller bearings.

Even though the axle A is in effect a full-floating axle, each bearing 24 has a narrow spread, and this renders their wheel ends 6 highly compact. Moreover, the wheel ends 6 produce only very minimal noise and vibration.

1. A solid axle for an automotive vehicle, said axle comprising:
an axle tube;
a housing secured to the end of the axle tube;
a hub having a drive flange located beyond the housing and a spindle that projects from the drive flange into the housing;
a bearing located between the hub spindle and the housing to enable the hub to rotate about an axis, the bearing including;
outer raceways carried by the housing;
inner raceways located around and carried by the hub spindle, at least one of the inner raceways being on an inner race that is initially separate from the hub spindle;
rolling elements located between the inner and outer raceways;
the raceways and the rolling elements being configured to transfer radial loads between the housing and hub and also thrust loads in both axial directions; and
an axle shaft in the axle tube and having at its end a drive spindle that projects into the hub spindle and is coupled to the hub spindle, so that it will rotate with and transfer torque to the hub and is captured axially in the hub spindle.

2. An axle according to claim 1 wherein the axle shaft retains the initially separate inner race on the hub spindle.

3. An axle according to claim 1 wherein the axle shaft has a shoulder from which the drive spindle emerges, and the shoulder bears against the initially separate inner race to retain it on the hub spindle.

4. An axle according to claim 3 wherein the drive spindle has a formed end that overlies a surface on the hub to prevent the axle shaft and the hub from separating.

5. An axle according to claim 4 wherein the rolling elements are organized in an outboard row and an inboard row, and the initially separate inner race provides the inner raceway for the rolling elements of the inboard row.

6. An axle according to claim 5 wherein the initially separate inner race has a back face and the shoulder of the axle shaft is against back face of the initially separate inner race.

7. An axle according to claim 4 wherein the hub has a wheel pilot that opens axially away from the hub and housing; and wherein the surface that the formed end of the axle shaft overlies is surrounded by the wheel pilot.

8. An axle according to claim 1 wherein the drive spindle of the axle shaft at its outboard end is deformed outwardly away from the axis to provide a formed end that overlies a surface of the hub and prevents the axle shaft from being withdrawn from the hub so as to unify the hub and axle shaft.

9. Unified assembly for a solid axle of an automotive vehicle, said unified assembly comprising:
a wheel end including:
a housing;
a hub having a drive flange located axially beyond the housing and a spindle that projects into the housing;
a bearing located between the housing and the hub spindle to enable the hub to rotate about an axis, the bearing including outboard and inboard outer raceways carried by the housing and spaced axially apart, outboard and inboard inner raceways carried by the hub around the hub spindle and presented outwardly toward the outboard and inboard outer raceways, respectively, the outboard raceways being inclined in one direction with respect to the axis and the inboard raceways being inclined in the other direction with respect to the axis, at least the inboard inner raceway being on a race that is initially separate from the hub spindle, and rolling elements located in an outboard row between the outboard raceway and in an inboard row between the inboard raceways; and
an axle shaft having at its end a drive spindle that projects into and is captured within the hub of the wheel end and being engaged with the hub such that it can transmit torque to the hub.

10. The unified assembly of claim 9 wherein the axle shaft has a shoulder from which the drive spindle projects and the shoulder is against the initially separate inner race.

11. The unified assembly of claim 9 wherein the drive spindle at its end is deformed outwardly in the provision of a formed end that overlies a surface of the hub, with that surface being presented away from the housing and bearing.

12. The unified assembly according to claim 11 wherein the initially separate inner race has a back face through which thrust loads that are taken by the bearing are transferred; and wherein the shoulder of the axle shaft is against the back face of the initially separate inner race.

13. A solid axle for an automotive vehicle; said solid axle including:
an axle center containing differential gearing;
axle tubes extending from the axle center along an axis;
a wheel end at the end of each axle tube, each wheel end including:
a housing secured to the axle tube;
a hub having a drive flange located beyond the housing and a spindle that projects into the housing; and
an antifriction bearing located between the housing and the hub spindle, the bearing being configured to transfer radial loads between the housing and spindle and also thrust loads in both axial directions; and
axle shafts at their inboard ends connected to the differential gearing such that the differential gearing can transfer torque to them and at their outboard ends being connected to the hubs of the wheel ends so that the torque is transferred to the hubs, the axle shafts at their outboard ends being captured in the hubs of the wheel ends so that the axle shafts and hubs are unified.

14. A solid axle according to claim 13 wherein the bearing of each wheel end has an inboard race that fits over the spindle of the hub and has an end face; and wherein the axle shaft that is coupled to the wheel end has a shoulder that bears against the end face of the bearing and a drive spindle that projects into the hub spindle.

15. A solid axle according to claim 14 wherein the drive spindle at its end projects outwardly over a surface of the hub such that the hub is captured between the shoulder and the outwardly projecting end of the drive spindle.

16. A solid axle according to claim 15 wherein the drive spindle is at its end deformed outwardly over the surface of the hub.
